(19) United States
(12) Patent Application Publication
(10) Pub. No.: US 2026/0079704 A1
(43) Pub. Date: Mar. 19, 2026

(54) ACCELERATING A FULLY HOMOMORPHIC ENCRYPTION (FHE) OPERATION WITH AN ON-CHIP SYSTOLIC ARRAY

(71) Applicant: INTERNATIONAL BUSINESS MACHINES CORPORATION, ARMONK, NY (US)

(72) Inventors: Rajat Rao, Bangalore (IN); Preetham M. Lobo, Bangalore (IN)

(21) Appl. No.: 18/885,269

(22) Filed: Sep. 13, 2024

(51) Int. Cl. G06F 9/30; G06F 15/80

(52) U.S. Cl. CPC G06F 9/3001; G06F 9/30047; G06F 15/8046

(57) ABSTRACT

Provided are techniques for accelerating a Fully Homomorphic Encryption (FHE) operation with an on-chip systolic array. A computer processing chip comprises an Artificial Intelligence (AI) accelerator comprising a direct memory access and a systolic array, a Level 3 (L3) cache connected to the AI accelerator, and a core connected to the AI accelerator and the L3 cache. The AI accelerator receives AI accelerator code from the core, where the AI accelerator code comprises new instructions, where the systolic array executes the new instructions using first data by executing a BMUL instruction to perform multiplication and generate first results, a BSUB instruction to perform subtraction using the first results to generate second results, and a BADDSUB instruction to perform modular correction on the second results to generate final results, and where the direct memory access prefetches second data for the systolic array.

### BACKGROUND

Embodiments of the invention relate to accelerating a Fully Homomorphic Encryption (FHE) operation with an on-chip systolic array.

Fully Homomorphic Encryption (FHE) provides a technique to perform operations on encrypted data, without first decrypting the data. FHE involves heavy modular arithmetic computation on large vectors.

For example, it is not uncommon to perform a modular Fast Fourier transform or Number Theoretic transform (NTT) on a polynomial vector of 65536 coefficients. The scale of these operations involved makes FHE 1,000 to 10,000 times slower than plaintext operations.

### SUMMARY

In accordance with certain embodiments, a computer processing chip for accelerating an FHE operation with an on-chip systolic array is provided. A computer processing chip comprises an Artificial Intelligence (AI) accelerator comprising a systolic array, a Level 3 (L3) cache connected to the AI accelerator, and a core connected to the AI accelerator and the L3 cache. The AI accelerator receives AI accelerator code from the core, where the AI accelerator code comprises new instructions, where the systolic array executes the new instructions using first data by executing a BMUL instruction to perform multiplication and generate first results, a BSUB instruction to perform subtraction using the first results to generate second results, and a BADDSUB instruction to perform modular correction on the second results to generate final results, and where the direct memory access prefetches second data for the systolic array.

In accordance with other embodiments, an Artificial Intelligence (AI) accelerator for accelerating an FHE operation with an on-chip systolic array is provided. The AI accelerator comprises a direct memory access connected to a Level 3 (L3) cache, a Level 2 (L2) cache connected to the direct memory access, a buffer connected to the L2 cache, a Level 1 (L1) cache connected to the buffer, and a systolic array connected to the L1 cache. The systolic array receives new instructions and executes the new instructions using first data by executing a BMUL instruction to perform multiplication and generate first results, a BSUB instruction to perform subtraction using the first results to generate second results, and a BADDSUB instruction to perform modular correction on the second results, and where the direct memory access prefetches second data for the systolic array.

In accordance with yet other embodiments, a computer-implemented method comprising operations is provided for accelerating an FHE operation with an on-chip systolic array. In such embodiments, an AI accelerator receives new instructions. A systolic array of the AI accelerator executes the new instructions using first data by executing a BMUL instruction to perform multiplication and generate first results, a BSUB instruction to perform subtraction using the first results to generate second results, and a BADDSUB instruction to perform modular correction on the second results to generate final results. While the systolic array executes the new instructions, a direct memory access of the AI accelerator prefetches second data for use by the systolic array. The AI accelerator returns the final results.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a Computer Processor (CP) chip in accordance with certain embodiments.

FIG. 3 illustrates an accelerator in accordance with certain embodiments.

FIG. 4 illustrates a systolic array in accordance with certain embodiments.

FIGS. 5A and 5B illustrate new instructions for modular multiplication reduction with AIU in accordance with certain embodiments.

FIG. 6 illustrates, in a flowchart, operations performed by the AI accelerator for processing data with prefetch in accordance with certain embodiments.

FIG. 7 illustrates transposed data in accordance with certain embodiments.

FIG. 8 illustrates a data access pattern for m=2 to m=2048 in accordance with certain embodiments.

FIG. 9 illustrates a data access pattern for m=4096 to m=16384 in accordance with certain embodiments.

FIG. 10 illustrates pipelined data flow in accordance with certain embodiments.

FIGS. 11A and 11B illustrate, in a flowchart, operations performed by the AI accelerator to overlap fetching data for one phase with processing data for another phase in accordance with certain embodiments.

FIG. 12 illustrates, in a flowchart, operations performed by the AI accelerator for executing a new instruction in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage media, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

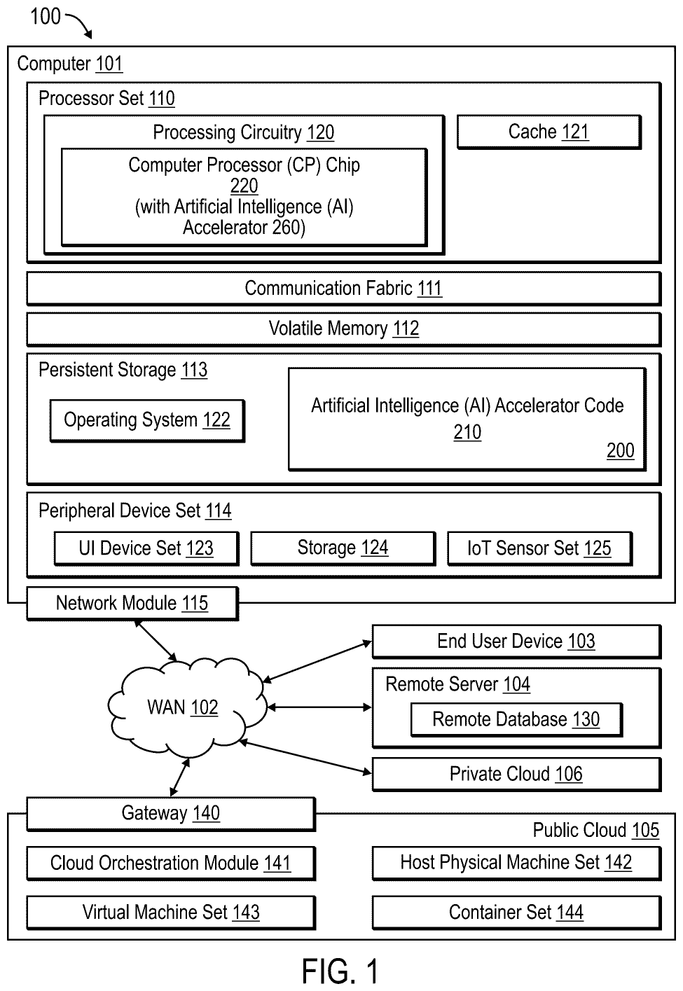

Computing environment 100 of FIG. 1 contains an example of an environment for the execution of at least some of the computer code involved in performing the inventive methods, such as Artificial Intelligence (AI) accelerator code 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. In certain embodiments, the processing circuitry 120 includes a Computer Processor (CP) chip 220 with an Artificial Intelligence (AI) accelerator 260 (i.e., which may be referred to as AI accelerator hardware).

In certain embodiments, the CP chip 220 is a combination of central processor units and accelerators (including the AI accelerator 260). That is, the CP chip 220 may be described as a general purpose processor chip with hardware AI acceleration enabled. The AI acceleration has both hardware (AI accelerator 260) and software (AI accelerator code 210). The AI accelerator code 210 that runs on the AI accelerator and orchestrates the data movement and computation may be read out of persistent storage and loaded onto the AI accelerator 260 at startup.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Embodiments utilize the CP chip 220 with large vector processing engines built on-chip. Embodiments use this hardware efficiently and gain an order of magnitude of performance over Central Processing Unit (CPU)-based computations. Embodiments prefetch data, and, by storing prefetched data in cache, speed up data access times by the on-chip systolic array.

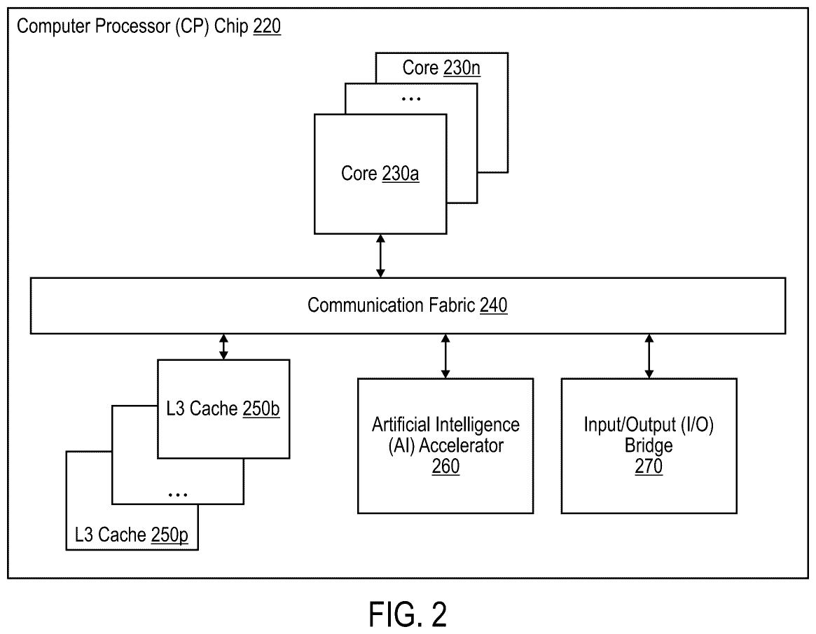

FIG. 2 illustrates a Computer Processor (CP) chip 220 in accordance with certain embodiments. The CP chip 220 (i.e., an integrated circuit) has a plurality of cores 230a . . . 230n connected to a communication fabric 240. In addition, Level 3 (L3) caches 250b . . . 250p are connected to the communication fabric 240. The AI accelerator 260 is connected to the communication fabric 240. In addition, an Input Output (IO) bridge 270 is connected to the communication fabric 240.

Each of the cores 230a . . . 230n may include a CPU for performing actions. The cores 230a . . . 230n use the L3 caches 250b . . . 250p as memory to store data. The AI accelerator 260 may prefetch data from the L3 caches 250b . . . 250p to accelerate FHE processing. The IO bridge allows each core 230a . . . 230n and the AI accelerator 260 to communicate with off-chip devices (e.g., external memory and/or other chips) that may be working together on a certain workload and sharing memory.

In various embodiments, the CP chip 220 may be utilized (e.g., in a server or enterprise machine) to provide dedicated on-chip AI processing.

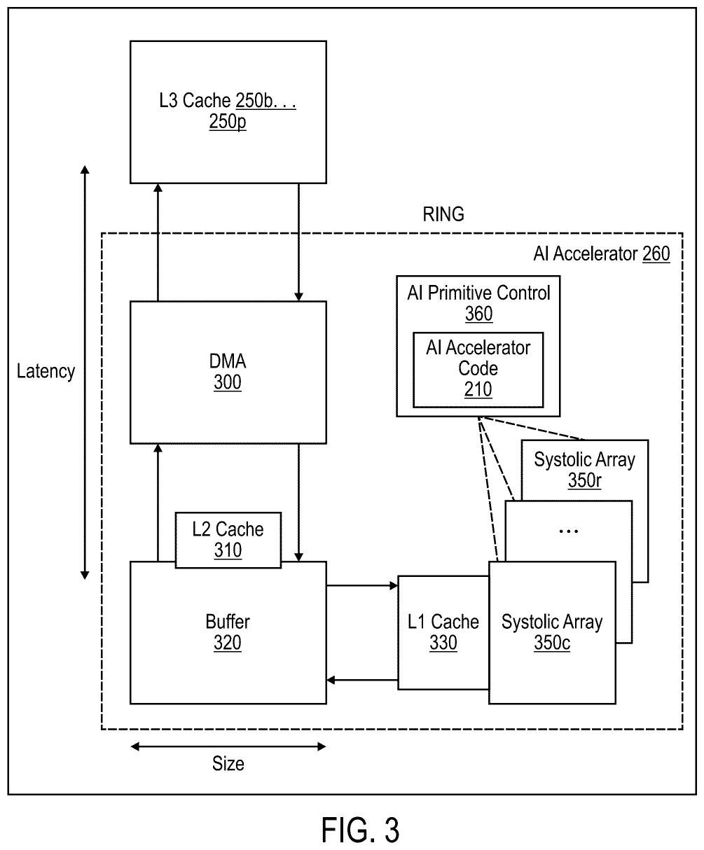

FIG. 3 illustrates an AI accelerator 260 in accordance with certain embodiments. In FIG. 3, the AI accelerator 260 includes a Direct Memory Access (DMA) 300, a Level 2 (L2) cache 310, a buffer 320, a Level 1 (L1) cache 330, and multiple systolic arrays 350c . . . 350r. In certain embodiments, there are multiple slices of the systolic array 350c . . . 350r. In addition, the AI accelerator 260 includes an AI primitive control 360. The AI accelerator code 210 is loaded into the AI primitive control 360, and the AI primitive control 360 executes the AI accelerator code 210 to send instructions to the systolic arrays 350c . . . 350r. The DMA 300 may be referred to as a DMA component.

DMA 300 is connected to L3 caches 250b . . . 250p and to L2 cache 310. In certain embodiments, the DMA 300 uses the L3 cache that is a lowest level L3 cache from L3 caches 250b . . . 250p. In certain embodiments, L2 cache 310 sits between the buffer 320 and the DMA 300. The DMA 300 moves data between the L3 caches 250b . . . 250p and the L2 cache 310. The buffer 320 is connected to a systolic array 350c . . . 350rc . . . 350r. L1 cache 330 sits between the buffer 320 and the systolic array 350c . . . 350r. The buffer 320 moves data from L2 cache 310 to L1 cache 330.

The DMA 300 allows access to the L3 caches 250b . . . 250p independently of the CPU. In certain embodiments, data to be processed by the systolic array 350c . . . 350r is stored in the L3 caches 250b . . . 250p (e.g., by the cores 230a . . . 230n). The DMA 300 retrieves the data from the L3 caches 250b . . . 250p and stores the data into the L2 cache 310. The buffer 320 retrieves the data from the L2 cache and stores the data into the L1 cache 330. The systolic array 350c . . . 350rc . . . 350r retrieves the data from the L1 cache 330, processes the data, and returns processed data to the L1 cache. Then, the buffer 320 moves the processed data from the L1 cache 330 to the L2 cache 310. The DMA 300 moves the processed data from the L2 cache 310 to the L3 caches 250b . . . 250p.

The ring in FIG. 3 may be described as a communication interface for the components that attach to the L3 cache 250b . . . 250p, including the cores 230a . . . 230n, the AI accelerator 260, and the IO bridge 270. In certain embodiments, a nest includes the L3 cache 250b . . . 250p, the AI accelerator 260, and the IO bridge 270.

In certain embodiments, the nest DMA performance is:

A bandwidth of 80 Gigabytes (GBs).

A transfer of 256 Bytes (B) in ˜50 nanoseconds (ns) from the L3 cache 250b . . . 250p to the L2 cache 310.

A pipelined transfer of 4 kilobytes (kB) per slice˜50 ns from the L3 cache 250b . . . 250p to the L2 cache 310.

A typical transfer latency of 128 KB˜4500 cycles from the L3 cache 250b . . . 250p to the L2 cache 310.

A subsequent 128 KB fetch/store is “hidden” while operating on the 128 KB. That is, the computation on the previously fetched 128 KB is done at the same time that the next 128 KB is being fetched from the L3 cache 250b . . . 250p.

In certain embodiments, the design of the nest DMA includes the local buffer 320 to hide the latency of fetching data from the L3 cache 250b . . . 250p to L2 cache 310.

Residue Number System (RNS) may be described as a mathematical process that splits up computations involving very large numbers into multiple computations involving smaller numbers that may then be combined together to get the same result. In certain embodiments, the size of the buffer 320 depends on the most commonly used parameter set to be accelerated and the size of the RNS split. In certain embodiments, a 512 KB buffer 320 is used, and such a buffer 320 fits in an area of 0.3 mm2.

In certain embodiments, the AI accelerator 260 uses a systolic array 350c . . . 350r available on-chip (i.e., on the CP chip 220), with proximity to cores 230a . . . 230n and L3 caches 250b . . . 250p, to perform and accelerate FHE operations. Unlike conventional systems that focus on off-chip acceleration (which has higher latency for setup and completion), embodiments provide the AI accelerator 260, which is a lower latency solution designed to minimize latency contribution of memory load/store operations.

In certain embodiments, the AI accelerator 260 presents the systolic array 350c . . . 350r with data from the shared L3 caches 250b . . . 250p via high bandwidth buses (i.e., communication fabric 240). The systolic array 350c . . . 350r design is enhanced by adding new instructions to perform FHE operations. The memory load/store into the systolic array 350c . . . 350r and the computations happening inside the systolic array 350c . . . 350r are carefully sequenced to hide the individual latency contributions. Also, a strided memory access technique using pipelining improves memory access patterns of the systolic array 350c . . . 350r as it performs the FHE operations.

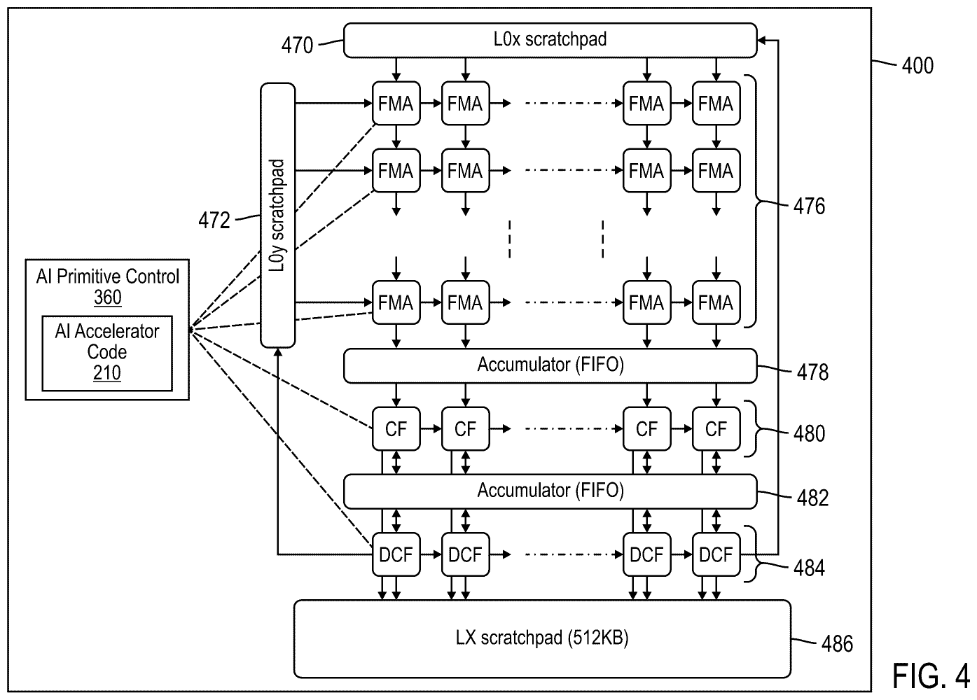

FIG. 4 illustrates a systolic array 400 in accordance with certain embodiments. Systolic array 400 is an example of one of the multiple systolic arrays 350c . . . 350r.

In certain embodiments, the systolic array 400 includes a L0x scratchpad 470, a L0y scratchpad 472, a Floating Multiple Accumulate (FMA) array 476, Accumulator (First In First Out (FIFO)) 478, Complex Functions (CFs) 480, Accumulator (FIFO) 482, Double Precision Complex Functions (DCFs) 484, and a Lx scratchpad 486.

In certain embodiments, an FMA may be referred to as a Processor Tile, a CF may be referred to as a Processing Element, and a DCF may be referred to as a Special Function Processor. With embodiments, for DCF, the floating point precision is double to that of CF.

In FIG. 4, one column of “FMA+CF+DCF” forms a slice of the systolic array 400. There may be multiple slices per systolic array (e.g., 8 slices). For example, one slice may do 8 FMA operations, and with 8 slices it becomes a total of 64 FMA

In certain embodiments, the FMAs in the FMA array 476 perform low precision floating point multiply accumulate operations. The CFs 480 perform the operations of the FMAs and some complex functions (e.g., exponential, ADDSUB, etc.). The DCFs perform the operations of the CFs and double precision operations.

In certain embodiments, the systolic array 400 pulls data from the L1 cache 330 and pushes the data to the L0x scratchpad 470 and the L0y scratchpad 472 of the systolic array 400. The data is processed by the systolic array 400 and processed data is stored in the Lx scratchpad 486. The systolic array 400 returns the processed data from the Lx scratchpad 486 to the L1 cache 330. Then, the buffer 320 moves the processed data from the L1 cache to the L2 cache 310, and the DMA 300 moves the processed data from the L2 cache 310 to the L3 caches 250b . . . 250p.

In certain embodiments, the FMA array 476 may comprise a two-dimensional compute fabric, with integer computation engines, that performs multiply-add operations to generate results that are stored in the accumulator (FIFO) 478.

The CFs 480 accept results from the accumulator (FIFO) 478, perform operations, and store results in the accumulator (FIFO) 482. The DCFs 484 accept results from the accumulator (FIFO) 482, perform operations, and send the results to the scratchpads 470, 472, 486. In certain embodiments, the CFs 480 and the DCFs 484 each comprise a one-dimensional compute row.

The FMA array 476, also called the matrix array, consists of FMAs, which may be regarded as organized as 8 rows and 8 columns of 16 bit Floating-Point (FP) FMAs (8×8×FP16) (i.e., 64 PTs). Each row is elementwise connected to the row below. The top row allows data pre-processing on inputs, and the bottom row sends results to the accumulator FIFO 478. A second stream of data is provided to the FMA array 476 from the west side (via the L0y scratchpad 472) and ripples through an FMA row to support efficient 2D-data computation. The FMA array 476 is used, for instance, to implement highly efficient matrix multiplication or convolution operations. In certain embodiments, each FMA implements an eight-way Single Instruction/Multiple Data (SIMD) engine optimized for multiply-accumulate operations. Each FMA may contain a local register file sized to cover the pipeline depth of the engine and to store a subset of weights for some AI operations.

The CFs 480 may comprise 64-way FP16 (16-bit floating-point) SIMD engines focused on area and power efficient implementation for arithmetic, logical, look-up and type conversion functions and output to the accumulator (FIFO) 482.

The DCFs 484 may be a superset of the CFs 480. The DCFs 484 may comprise 42-way FP32/64-way FP16 SIMD. The DCFs 484 may also support horizontal operations, such as shifting left/right across engines or computing a sum-across all elements of all DCFs 484. This compute array may be used either for all non-systolic functions or for data preparation and gathering for systolic functions.

In certain embodiments, the data flow for the systolic array 400 starts with prefetch from the L1 cache 330, which loads data into the L0y scratchpad 472 (e.g., a 512 KiloByte (KB) scratchpad). The L0y scratchpad 472 may be organized in multiple sections to enable double-buffering of data and compute streams to allow overlapping of prefetching, compute and write-back phases to maximize parallelism within the accelerator and increase the overall performance. The translated physical addresses for input and output data are provided by the firmware running on the general purpose core. Data from the L0y scratchpad 472 arrives at the FMAs in the format and layout required by the AI operation executed. If needed, additional data manipulation is done by the CFs 480 and/or DCFs 484 before sending that data to the FMAs via the L0x scratchpad 470 or through the L0y scratchpad 472. The results are collected from the Lx scratchpad 486 by the writeback engine and stored back to caches or memory.

In certain embodiments, the AI primitive control 360 executes the AI accelerator code 210 to send BMUL instructions to the FMAs and to send BSUB and BADDSUB instructions to either the CFs or the DCFs.

Regarding the strided access pattern, in a phase 16K elements (if each element is 8 B, then 128 KB buffer is used in the internal LX scratchpad 486), and for m=2 to m=2048, the values in the buffer are such that val0, val1 (for a given m) may be computed in the same slice. After m=4096, the values are transposed so that again the transposed val0, val1 may be computed in the same slice as it is more efficient to do arithmetic in the same slice of the systolic array 400. Reserving 128K buffer per phase also helps in efficiently splitting the 512 KB scratch bad into 4 sub buffers so that two buffers may be used actively for the ongoing phase and the other two are available for fetching data for the next phase so as to improve performance.

In certain embodiments, the AI accelerator 260 performs prefetch of data for accelerating the FHE operations. FHE performs arithmetic (e.g., addition/multiplication) on encrypted data. The FHE operations are polynomial operations and have evolved from lattice-based Learning With Errors (LWE). The degree of the polynomial may be limited to the underlying polynomial modulus. The coefficients of the polynomial may be limited to the ciphertext modulus.

In certain embodiments, the encryption schemes for the polynomials may be the Brakerski-Gentry-Vaikuntanathan (BGV) encryption scheme, the Brakerski/Fan-Vercauteren (BFV) encryption scheme, the Cheon-Kim-Kim-Song (CKKS) encryption scheme, or other encryption schemes. BGV, BFV, and CKKS encryption schemes are popular for vector operations. TFHE (another encryption scheme that is also known as CGGI, from the names of the authors Chillotti-Gama-Georgieva-Izabachène) is popular for multi-party FHE.

In conventional systems, modular multiplication (e.g., Barrett modular multiplication) may set the following: k=bitwidth; a=operand; b=operand; p=prime; and Return: r=(a*b) % p. The modular multiplication may precompute μ (μ=floor (2^{2k}/p), perform binary multiplication for variable w1 (w1=a*b); perform binary multiplication for variable x1 (x1=w1 (1+hi)*μ); perform binary multiplication for variable y1 (y1=x1 (1+hi)*p); perform binary subtraction for variable z (z=w1 (lo+1)−r2 (lo+1)); and correct for variable res (res—Add 2^{k+1} or subtract p or subtract 2p). Embodiments provide

Res (i.e., correct r) may be described as modular correction. The final operation of the modular multiplication operations produces a result that may be the result of an addition and hence greater than the modulus or the result of a subtraction, which may be less than zero (0). For modular arithmetic, the correction operation subtracts the modulus from the result or adds the modulus to the result, respectively, to ensure the final value is positive and less than the modulus.

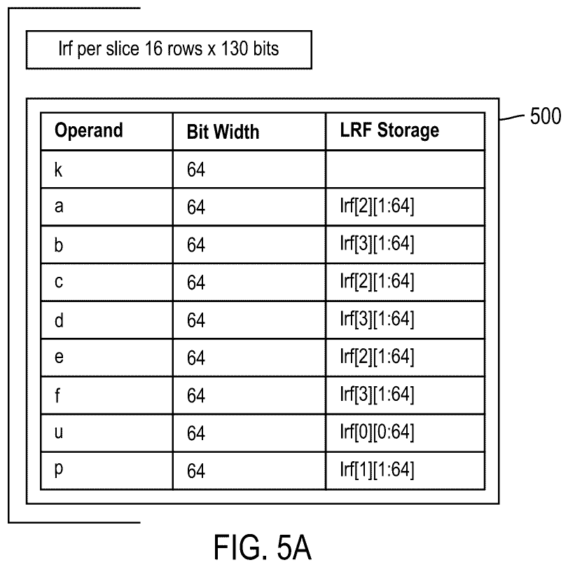

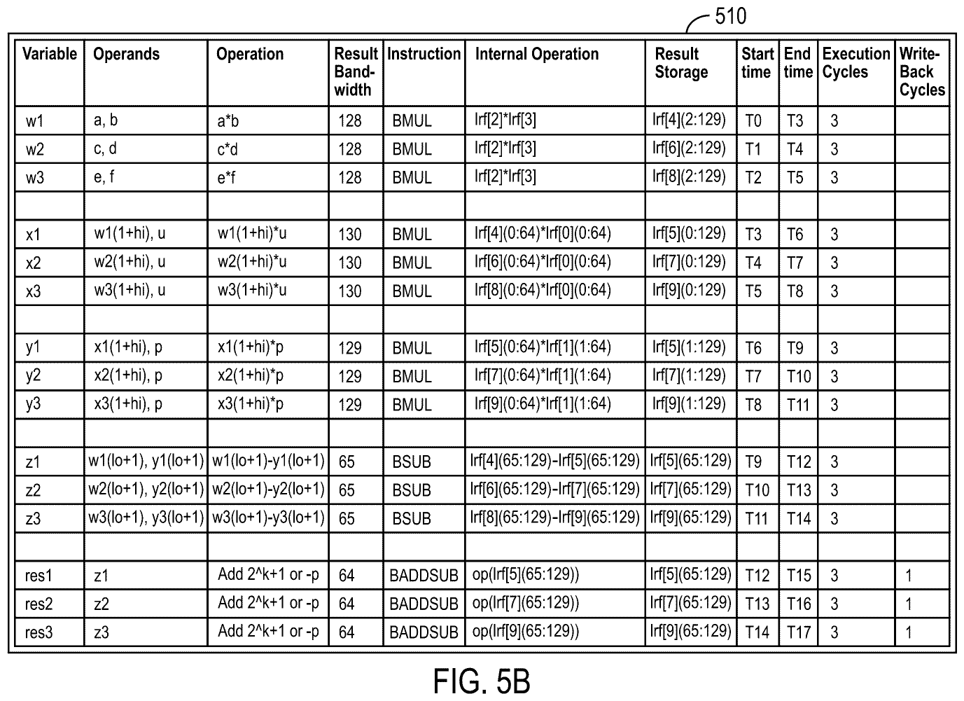

FIGS. 5A and 5B illustrate new instructions for modular multiplication reduction with AIU in accordance with certain embodiments. In certain embodiments, this is Barrett modular multiplication reduction. Embodiments provide new instructions BMUL, BSUB, and BADDSUB.

In certain embodiments, when an FHE operation is received by a core, the core offloads the FHE operation processing to the AI accelerator 260. The systolic arrays 350c . . . 350r of the AI accelerator 260 implement new instructions for the FHE operation. In certain embodiments, the AI accelerator code 20 may be described as a low-level assembly code with multiple instructions. The FHE operation is executed by executing these multiple instructions. These multiple instructions include the 15 BMUL, BSUB, and BADDSUB instructions in the instructions column of table 510 and also some existing instructions of the accelerator. The AI primitive control 360 issues each of the 15 instructions to one of the FMAs, CFs or DFs of the systolic array 350r . . . 350c.

In certain embodiments, the AI accelerator code 210 performs other AI operations.

The Local-Register-File (LRF or Irf) per slice is 16 rows×130 bits. An LRF is a register file, which is a data structure that holds the temporary operands and results. The LRF is local as it is part of the CFs. Table 500 illustrates the operands (i.e., parameters), with bit width and LRF storage. Table 510 illustrates, for each variable and associated operands, an operation, a result bandwidth, a new instruction (which is a BMUL, BSUB or BADDSUB instruction), an internal operation, a result storage, a start time, an end time, execution cycles, and Write-Back (WB) cycles. A WB operation is responsible for storing the result of the execution of the instruction. The systolic array 350c . . . 350r performs (i.e., executes) the new instruction.

In certain embodiments, two 64-bit input variables that are to be multiplied under a modulus are read in from the LRF. These are split-up into four 16-bit inputs each. To perform the multiplication of these two numbers via the BMUL instruction, the systolic array 350c . . . 350r computes a total of 16 partial products and sums them up using 2 slices of 8 FMAs each. The systolic array 350c . . . 350r allows for one of the input variables to be 65 bits in width, where an extra partial product addition is performed to generate a 129-bit result. For an embodiment having a greater number of slices, numerous such multiplications may be performed in parallel. Each such multiplication may take multiple clocks (e.g., 3 clocks). In addition, since the FMAs are designed to work in a pipelined manner, another set of inputs (which are prefetched by the DMA 300) may be fed into the FMAs in the second and third clock cycle to improve the overall iteration interval. As per the modular multiplication algorithm, three such multiplications are performed, and the corresponding results w1, w2, w3, x1, x2, x3, y1, y2, y3, z1, z2, and z3 are computed and written into the LRF. These results are up to 129 bits in width and stored in the accumulator FIFO 478 (i.e., first results). The BSUB instruction is executed on the CFs or DCFs using the results stored in the accumulator FIFO 478, where each slice computes the subtraction of two 65-bit numbers with appropriate borrow bit propagation across slices, and the results are stored in the accumulator FIFO 482 (i.e., second results). The pipelining of the DCFs allows new inputs to be processed every cycle, while a given BSUB instruction may take up to three clocks. The BADDSUB instruction uses the results stored in the accumulator FIFO 482 and implements the modular correction operation on the CFs or DCFs.

With embodiments, k, u, and p are parameters specific to a particular modulus under which the FHE operation is being performed and maps to three constant entries in the LRF. With embodiments, a, b, c, d, e, and f are input variables that undergo a modular multiplication operation. For example, w1, w2, w3, x1, x2, x3, y1, y2, y3, z1, z2, and z3 are intermediate results of the FHE operation, and res1, res2, and res3 are the final results of the FHE operation. In certain embodiments, a total of 10 LRF entries may be used to perform a pipelined modular multiplication operation by reusing and overwriting entries that are no longer required. The notation (1+hi) denotes one bit from the lower half along with the higher half bits. Similarly (lo+1) indicates the lower half bits along with one bit from the higher half. For a 129-bit result, both these notations indicate picking the higher or lower 65 bits respectively. In certain embodiments, the overall FHE operation computes 3 modular multiplications in 17 clocks including a write-back cycle.

In certain embodiments, for an a*b operation in the code, a compiler/assembler maps the a*b operation to lrf entries of lrf[2]*Irf [3]. That is, for an a*b operation, the AI accelerator 260 takes two Irf entries, computes the product, and stores the result to a third entry.

In certain embodiments, the AI accelerator 260 accelerates execution of a Number-Theoretic Transform (NTT). For the NTT algorithm, the input is a polynomial of a(x) [symbol] Z_{q}[x] of degree n−1 and n-th primitive root wₙ [symbol] Z_{q} of unity. For the NTT algorithm, the output is a polynomial A(x) [symbol] Z_{q}[x]=NTT(a). The AI accelerator 260 enables more efficient processing of the NTT algorithm. For example, storing (wₘ←w^{n/m}ₙ) uses very small storage (e.g., for n=65536, 16 elements are used and this may be fetched after each stage). In addition, embodiments prefetch data for variables k, j, and m (e.g., for t←w*A[K+j+m/2] and u←A[K+j]) from the L1 cache and the L2 cache to accelerate processing, and these variables k, j, and m may be fetched every cycle. Moreover, in the NTT algorithm, for subtraction and addition operations, the AI accelerator 260 executes the BSUB and BADDSUB instructions (e.g., u−t and u+t). Also, in the NTT algorithm, for multiplication operations, the AI accelerator 260 executes the BMUL instruction for multiplication (e.g., w←w*wₘ). With embodiments, computing (w←w*wₘ) takes n/2 extra multiplications, with a 10-15% overhead, which cases memory bandwidth and buffer size requirements.

The implementation of modular arithmetic instructions, which allow the computation of a wider product, and the implementation of the BADDSUB instruction, which allows implementing the modular correction step in a single instruction call, accelerates the compute intensive portions of the NTT algorithm. The weight factor used in the inner loop of the NTT algorithm is reused across the loop iterations with the fetch access pattern from the buffer to the compute element optimized in a way that keeps the next operand ready for processing while the current loop iteration is running.

In certain embodiments, the AI accelerator code 210 that executes via the AI primitive control 360 is written so that that an entire FHE operation is divided into phases and super-phases with the state information at the end of each super-phase made available in memory to the higher level software executing on the cores 230a . . . 230n. This allows the cores 230a . . . 230n to interrupt the AI accelerator 260 in the middle of a long-running job. Embodiments enable the creation of the phases supporting the ability to interrupt to allow the AI accelerator 260 to be virtualized where a system level scheduler handles time-slicing of various jobs by mapping the jobs to a common hardware resource, the AI accelerator 260.

That is, the AI accelerator code 210 for the FHE operation executing on the AI accelerator 260 is broken up into phases, where each phase processes a fraction of the total data. Also, each individual phase is created such that the CPU code (e.g., firmware code) of a core 230a . . . 230 may interrupt the FHE operation at the end of a current phase of multiple phases and the AI accelerator 260 stores partial data generated until that phase. Furthermore, once the CPU code has serviced the interrupt, the AI accelerator 260 resumes executing the FHE operation starting at a next phase of the multiple phases, with the partial data computed till the previous phase, and continues further until another interruption or final completion of the FHE operation.

Thus, an instruction may be executed in phases. The ability to interrupt allows the AI accelerator 260 to receive an interrupt (from a core 230a . . . 230n) at the end of a phase or a superphase, and the AI accelerator 260 stops processing instruction. An example of a phase may be the computation of one iteration of the NTT algorithm, and a super-phase may be a collection of phases where the entire NTT is computed within a larger FHE processing job.

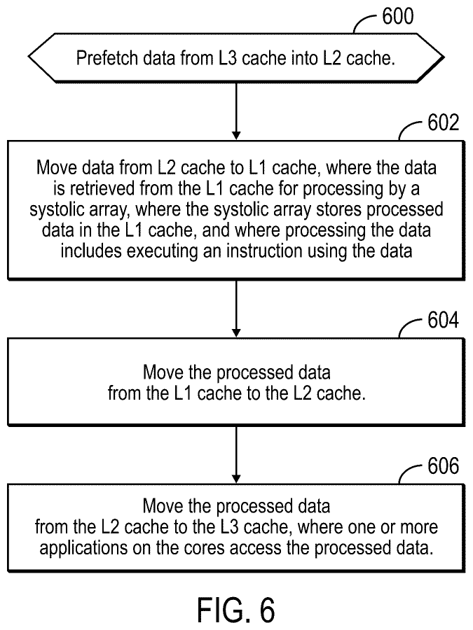

FIG. 6 illustrates, in a flowchart, operations performed by the AI accelerator 260 for processing data with prefetch in accordance with certain embodiments. Control begins at block 600 with the DMA 300 prefetching data from the L3 cache 250b . . . 250p into the L2 cache 310. In block 602, the buffer 320 moves the data from the L2 cache 310 to the L1 cache 330, where the data is retrieved from the L1 cache 330 for processing by a systolic array, and where the systolic array stores processed data in the L1 cache 330, and where processing the data includes executing an instruction using the data.

In block 604, the buffer 320 moves the processed data from the L1 cache 330 to the L2 cache 310. In block 606, the DMA 300 moves the processed data from the L2 cache 310 to the L3 cache 250b . . . 250p, where one or more one or more applications on the cores 230a . . . 230n access the processed data.

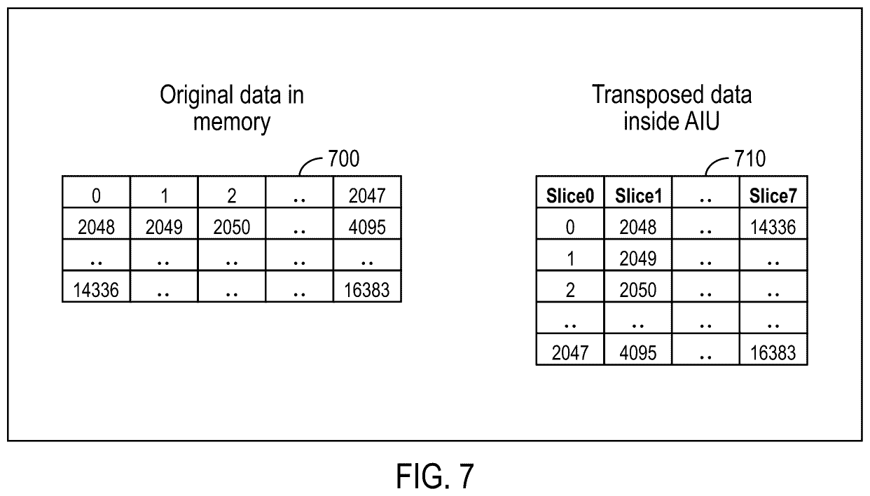

FIG. 7 illustrates transposed data in accordance with certain embodiments. In FIG. 7, table 700 illustrates original data in cache L3 250b . . . 250p (i.e., memory), while table 710 illustrates transposed data inside the buffer 320. In certain embodiments, the systolic array 350c . . . 350r transposes the original data to enable more data to fit in the buffer 320 and the Lx scratchpad 486.

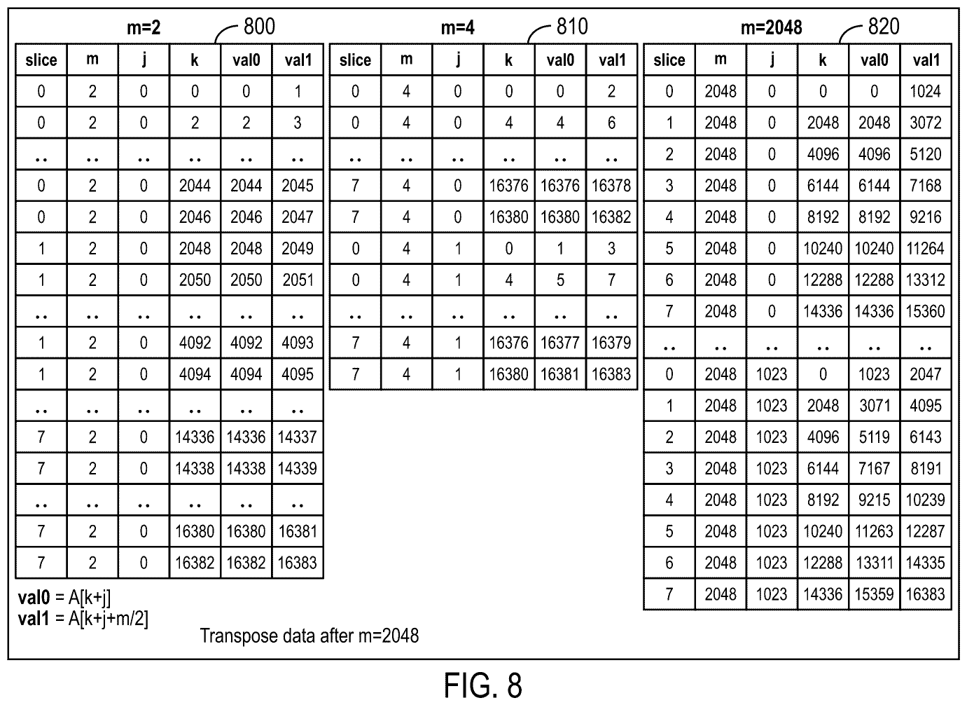

FIG. 8 illustrates a data access pattern for m=2 to m=2048 in accordance with certain embodiments. The data access pattern reflects the data Table 800 illustrates data for m−2, table 810 illustrates data for m=4, and table 820 illustrates data for m=2048. In table 810 and 820, the values of val0 and val1 are close, but these values are far apart at m=2048. Therefore, the data is transposed after m=2048.

Val0 and val1 refer to values in the A matrix that are used within each inner loop iteration of the NTT algorithm 600. These two values within the A matrix correspond to neighboring or nearby entries initially, but as the NTT algorithm 600 progresses, it requires values that are further apart. To exploit storage locality better, the systolic array 350c . . . 350r of the AI accelerator 260 performs a transpose of the matrix in the buffer 320.

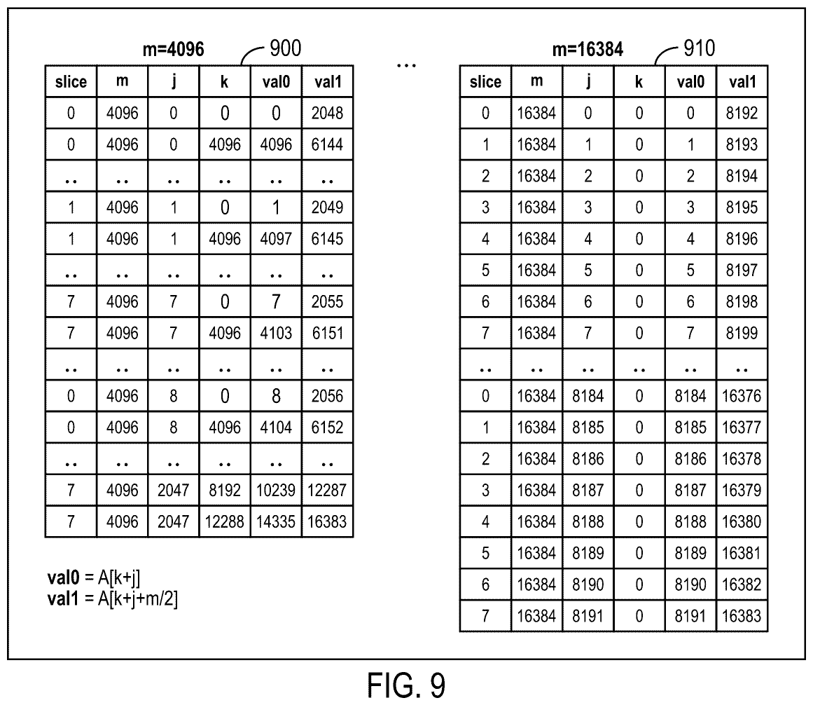

FIG. 9 illustrates a data access pattern for m=4096 to m=16384 in accordance with certain embodiments. Table 900 illustrates data for m=4096 and table 910 illustrates data for m=16384.

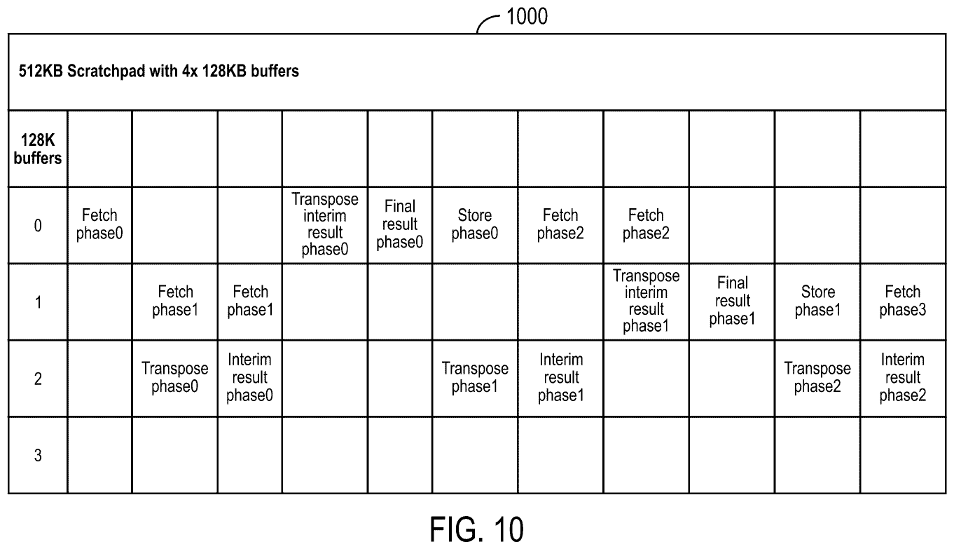

FIG. 10 illustrates pipelined data flow in accordance with certain embodiments. In certain embodiments, the scratchpad is has 512 KB and is divided into four 128 KB buffers. Table 1000, for the 512 KB scratchpad, includes a row for each of the four 128 KB buffers: buffer0, buffer1, buffer2, buffer3.

The AI accelerator 260 uses a double buffering scheme in pico-code to overlap fetching data for a next phase (N+1) and execution of current phase (N). In certain embodiments, the overlap indicates that the fetching and execution are concurrent in time or during a same period of time. For example, embodiments use buffer0 for fetch phase0. Once data is fetched for phase0 in buffer0, embodiments start fetching data for phase 1 into buffer1. While phase1 data is fetched, embodiments use buffer2 to store phase0 transpose and interim results of phase0. Then, the next transpose of phase0 interim results is kept in buffer0, and the final result is stored back from buffer0. When phase0 result is getting stored from buffer0, embodiments use buffer2 for transpose and interim results of phase 1, and the process continues.

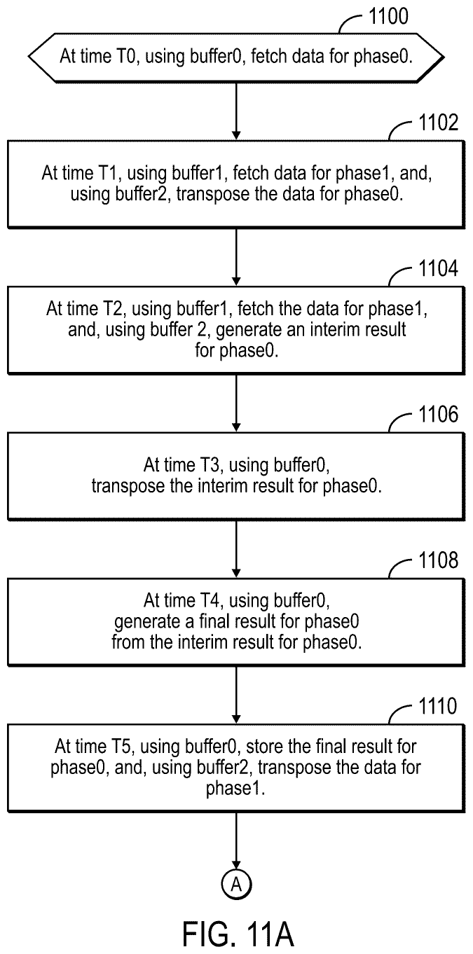

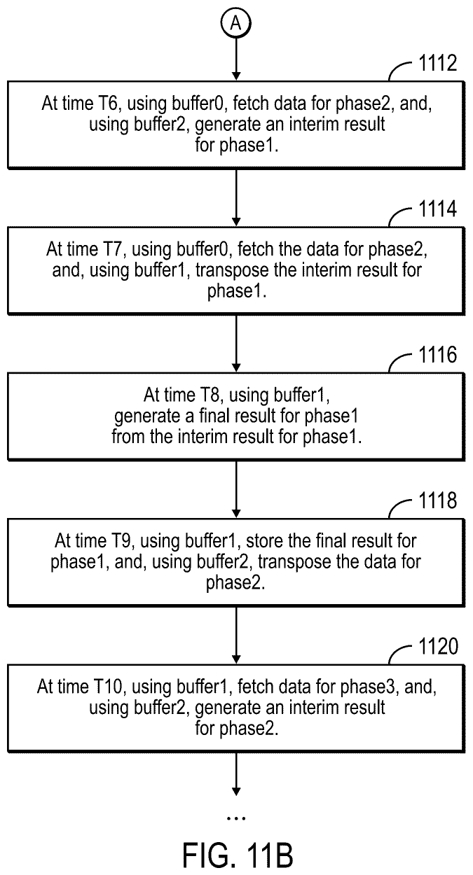

FIGS. 11A and 11B illustrate, in a flowchart, operations performed by the AI accelerator 260 to overlap fetching data for one phase with processing data for another phase in accordance with certain embodiments. Operations for fetching data or storing data may overlap with operations for processing the data (e.g., transposing the data, generating an interim result, generating a final result, etc.). The overlapping operations may be said to occur at (or start at) a particular time (T), occur in a particular cycle or occur in a particular time period.

Control begins at block 1100, at time TO, with the DMA 300, using buffer0, fetching data for phase0. In block 1102, at time T1, the DMA 300, using buffer1, fetches data for phase 1, and the systolic array 350c . . . 350r, using buffer2, transposes the data for phase0.

In block 1104, at time T2, the DMA 300, using buffer1, fetches the data for phase1 (i.e., continues fetching the data for phase1), and, the systolic array 350c . . . 350r, using buffer2, generates an interim result for phase0.

In block 1106, at time T3, the systolic array 350c . . . 350r, using buffer0, transposes the interim result for phase0.

In block 1108, at time T4, the systolic array 350c . . . 350r, using buffer0, generates a final result for phase0 (from the transposed interim result for phase0).

In block 1110, at time T5, the DMA 300, using buffer0, stores the final result for phase0, and, the systolic array 350c . . . 350r, using buffer2, transposes the data for phase1. From block 1110 (FIG. 11A), processing continues to block 1112 (FIG. 11B).

In block 1112, at time T6, the DMA 300, using buffer0, fetches phase2 data, and, the systolic array 350c . . . 350r, using buffer2, generates an interim result for phase1.

In block 1114, at time T7, the DMA 300, using buffer0, fetches the data for phase2 (i.e., continues fetching the data for phase2), and, the systolic array 350c . . . 350r, using buffer1, transposes the interim result for phase1.

In block 1116, at time T8, the systolic array 350c . . . 350r, using buffer1, generates a final result for phase1 (from the transposed interim result from phase1).

In block 1118, at time T9, the DMA 300, using buffer1, stores the final result for phase1, and, the systolic array 350c . . . 350r, using buffer2, transposes the data for phase2.

In block 1120, at time T10, the DMA 300, using buffer1, fetches data for phase3, and, the systolic array 350c . . . 350r, using buffer2, generates an interim result for phase2.

The ellipses of FIG. 11B indicate that this type of processing continues to enable prefetching new data and processing previously (i.e., at a previous point in time) prefetched data to overlap for efficient processing.

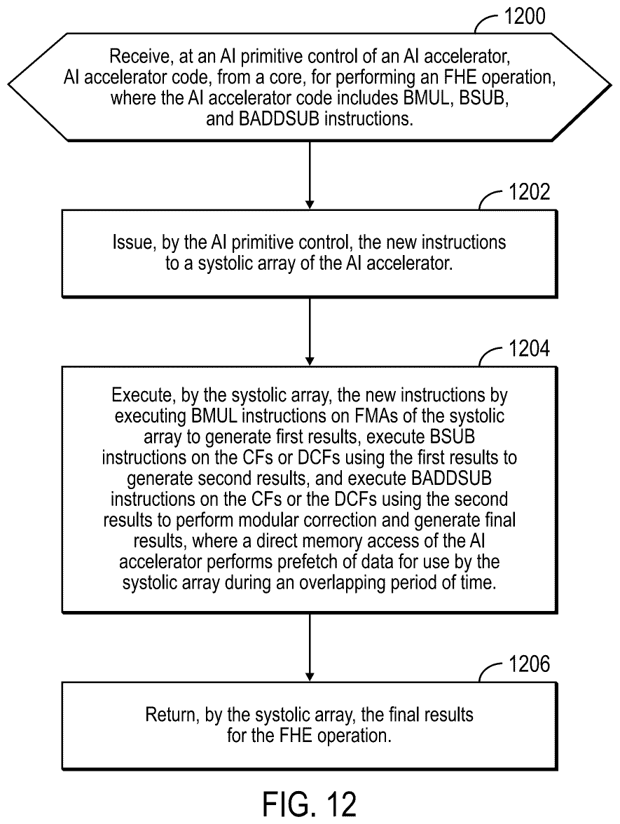

FIG. 12 illustrates, in a flowchart, operations performed by the AI accelerator for executing a new instruction in accordance with certain embodiments. Control begins at block 1200 with an AI primitive control 360 of an AI accelerator 260, receiving AI accelerator code 210, from a core 230a . . . 230n, for performing an FHE operation, where the AI accelerator code 210 includes BMUL, BSUB, and BADDSUB instructions. In certain embodiments, the core 230a . . . 230n provides a memory address for the AI primitive control 360 to fetch the AI accelerator code 210 (i.e., the core 230a . . . 230n indirectly provides the AI accelerator 260 with the AI accelerator code 210). With embodiments, the AI accelerator code 210 includes the new instructions BMUL, BSUB, and BADDSUB instructions along with existing, legacy instructions.

In block 1202, the AI primitive control 360 issues the new instructions to a systolic array 350c . . . 350r of the AI accelerator 260. In block 1204, the systolic array 350c . . . 350r executes the new instructions by executing BMUL instructions on FMAs of the systolic array 350c . . . 350r to generate first results, executing BSUB instructions on the CFs or DCFs 350c . . . 350r using the first results to generate second results, and executing BADDSUB instructions on the CFs or the DCFs 350c . . . 350r using the second results to perform modular correction and generate final results, where a DMA 300 of the AI accelerator 260 performs prefetch of data for use by the systolic array 350c . . . 350r during an overlapping period of time.

In block 1206, the systolic array returns the final results for the FHE operation. The final results may be returned to the L1 cache 330, and then the final results are returned via the buffer from the L1 cache 330 to the L2 cache 310 and via the DMA 300 to the L3 cache 250b . . . 250p for access by the cores 230a . . . 230n. With embodiments, the final result may vary. In particular, due to the AI primitive control 360, the meaning of the final result depends on the application. For example, the AI accelerator 260 may be invoked to accelerate a part of a fully homomorphic encryption operation, such as NTT, relinearization, etc. In addition, the AI accelerator 260 may perform the entire operation without requiring additional pre- or post-processing operations.

In certain embodiments, the AI accelerator 260 is used to accelerate FHE operations. A new BMUL instruction on the systolic array 350c . . . 350r performs a 32-bit multiplication across all slices. A new BSUB instruction on the systolic array 350c . . . 350r performs a 32-bit or a 64-bit subtraction across all slices. A new BADDSUB instruction on a systolic array 350c . . . 350r performs a 32-bit or a 64-bit modular correction operation.

In certain embodiments, vector processing hardware of different widths (32-bit, 64-bit) at different stages is used for more efficiency. That is, the FMAs, CFs, and DCFs may be designed different in different embodiments for area versus compute capability efficiency. With embodiments, smaller compute engines generate partial multiplication and/or double width multiplication results and larger engines handle addition/subtraction to keep the overall area compact. For example, a larger number of FMAs are used to generate partial products, and CF is used to handle the first stage of add/sub followed by DCF for the second stage of add/sub in a modular multiplication operation. The CF and DCF may be designed to handle larger operand widths.

In certain embodiments, the cores 230a . . . 230n (which are programmable) are attached to an AI accelerator 260, which includes a systolic array 350c . . . 350r. The systolic array 350c . . . 350r performs: transposing data to improve NTT computation access pattern; strided access patterns across slices of the systolic array 350c . . . 350r to improve performance; and pipelining and overlapping memory load/store operations with systolic array computations to reduce overall latency.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A computer processing chip, comprising:
an Artificial Intelligence (AI) accelerator comprising:
a direct memory access;
a Level 2 (L2) cache connected to the direct memory access;
a buffer connected to the L2 cache;
a Level 1 (L1) cache connected to the buffer;
a systolic array connected to the L1 cache; and
an AI primitive control;
a Level 3 (L3) cache connected to the AI accelerator;
a core connected to the AI accelerator and the L3 cache; and
wherein the AI primitive control of the AI accelerator receives AI accelerator code from the core, wherein the AI accelerator code comprises new instructions, wherein the systolic array executes the new instructions using first data by executing a BMUL instruction to perform multiplication and generate first results, a BSUB instruction to perform subtraction using the first results to generate second results, and a BADDSUB instruction to perform modular correction on the second results to generate final results, and wherein the direct memory access prefetches second data for the systolic array from the L3 cache and stores the second data in the L2 cache, a buffer moves the second data from the L2 cache to the L1 cache, and wherein the systolic array retrieves the second data from the L1 cache.

2. The computer processing chip of claim 1, wherein the systolic array further comprises Floating Multiple Accumulates (FMAs), Complex Functions (CFs), and Double Precision Complex Functions (DCFs), and wherein the AI primitive control stores the AI accelerator code.

3. The computer processing chip of claim 2, wherein the AI primitive control executes the AI accelerator code to execute the new instructions by sending BMUL instructions to the FMAs to generate first results, sending BSUB instructions to one of the CFs and the DCFS to process the first results and generate second results, and sending BADDSUB instructions to one of the CFs and the DCFs to perform modular correction on the second results.

4. The computer processing chip of claim 1, wherein the direct memory access prefetches the second data from the L3 cache during an overlapping period of time in which the systolic array executes the new instructions with the first data.

5. The computer processing chip of claim 1, wherein executing the new instructions comprises transposing the first data, generating interim results using the transposed data, transposing the interim results, and generating final results from the interim results.

6. The computer processing chip of claim 1, wherein the new instructions perform a fully homomorphic encryption operation, and wherein the fully homomorphic encryption operation is executed in phases, and wherein the AI accelerator receives an interrupt to stop executing the fully homomorphic encryption operation at an end of a current phase of the phases and to save partial data.

7. The computer processing chip of claim 6, wherein the AI accelerator resumes executing the fully homomorphic encryption operation at a next phase of the phases using the saved, partial data.

8. An Artificial Intelligence (AI) accelerator on a chip with a Level 3 (L3) cache and a core, comprising:
a direct memory access connected to the Level 3 (L3);
a Level 2 (L2) cache connected to the direct memory access;
a buffer connected to the L2 cache;
a Level 1 (L1) cache connected to the buffer;
a systolic array connected to the L1 cache;
an AI primitive control with AI accelerator code connected to the systolic array;
wherein the AI primitive control executes the AI accelerator code to send new instructions to the systolic array; and
wherein the systolic array receives the new instructions and executes the new instructions using first data by executing a BMUL instruction to perform multiplication and generate first results, a BSUB instruction to perform subtraction using the first results to generate second results, and a BADDSUB instruction to perform modular correction on the second results, and wherein the direct memory access prefetches second data for the systolic array from the L3 cache and stores the second data in the L2 cache, a buffer moves the second data from the L2 cache to the L1 cache, and wherein the systolic array retrieves the second data from the L1 cache.

9. The AI accelerator of claim 8, wherein the systolic array further comprises Floating Multiple Accumulates (FMAs), Complex Functions (CFs), and Double Precision Complex Functions (DCFs).

10. The AI accelerator of claim 9, wherein the AI primitive control executes the AI accelerator code to send BMUL instructions to the FMAs, and wherein the AI primitive control executes the AI accelerator code to send BSUB instructions and BADDSUB instructions to one of the CFs and the DCFs.

11. The AI accelerator of claim 8, wherein the direct memory access prefetches the second data from the L3 cache during an overlapping period of time in which the systolic array executes the new instructions with the first data.

12. The AI accelerator of claim 8, wherein executing the new instructions comprises transposing the first data, generating interim results using the transposed data, transposing the interim results, and generating final results from the interim results.

13. The AI accelerator of claim of claim 8, wherein the new instructions perform a fully homomorphic encryption operation, and wherein the fully homomorphic encryption operation is executed in phases, and wherein the AI accelerator receives an interrupt to stop executing the fully homomorphic encryption operation at an end of a current phase of the phases and to save partial data.

14. The AI accelerator of claim of claim 13, wherein the AI accelerator resumes executing the fully homomorphic encryption operation at a next phase of the phases using the saved, partial data.

15. A computer-implemented method, comprising operations for:
receiving, with an AI accelerator, new instructions;
executing, using a systolic array of the AI accelerator, the new instructions using first data by executing a BMUL instruction to perform multiplication and generate first results, a BSUB instruction to perform subtraction using the first results to generate second results, and a BADDSUB instruction to perform modular correction on the second results to generate final results;
prefetching, using a direct memory access of the AI accelerator, second data for the systolic array from an L3 cache for storage in an L2 cache, wherein a buffer moves the second data from the L2 cache to an L1 cache, and wherein the systolic array retrieves the second data from the L1 cache; and
returning, with the AI accelerator, the final results.

16. The computer-implemented method of claim 15, wherein the systolic array further comprises Floating Multiple Accumulates (FMAs), Complex Functions (CFs), and Double Precision Complex Functions (DCFs), and wherein the AI accelerator further comprises an AI primitive control that stores AI accelerator code.

17. The computer-implemented method of claim 16, wherein the AI primitive control executes the AI accelerator code to send BMUL instructions to the FMAs, and wherein the AI primitive control executes the AI accelerator code to send BSUB instructions and BADDSUB instructions to one of the CFs and the DCFs.

18. The computer-implemented method of claim 15, wherein the direct memory access prefetches the second data from the L3 cache during an overlapping period of time in which the systolic array executes the new instructions with the first data.

19. The computer-implemented method of claim 15, wherein executing the new instructions comprises transposing the first data, generating interim results using the transposed data, transposing the interim results, and generating final results from the interim results.

20. The computer-implemented method of claim 15, wherein the new instructions perform a fully homomorphic encryption operation, and wherein the fully homomorphic encryption operation is executed in phases, and wherein the AI accelerator receives an interrupt to stop executing the fully homomorphic encryption operation at an end of a current phase of the phases and to save partial data.
